(19) United States
(12) Patent Application Publication
(10) Pub. No.: US 2006/0127080 A1
(43) Pub. Date: Jun. 15, 2006

(54) Digital single-reflex camera

(75) Inventors: Nobuyuki Mori, Osaka (JP); Satoshi Yokota, Osaka (JP); Tsutomu Ichikawa, Osaka (JP); Makoto Akesaka, Osaka (JP); Kazumi Kageyama, Osaka (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/243,110

(22) Filed: Oct. 4, 2005

(30) Foreign Application Priority Data
Dec. 9, 2004 (JP) 2004-356253

(51) Int. Cl. G03B 13/34

(52) U.S. Cl. 396/121; 396/125

(57) ABSTRACT

When a selector button is pressed in optical viewfinder mode, a display in live view mode is started. If the metered light value, measured focus detection result, and position information stored in the optical viewfinder mode are set so as to be reflected in the live view mode, exposure control is performed based on the stored metered light value and position information, and focusing is performed based on the stored focus detection result and position information.

This application is based on the application No. 2004-356253 filed in Japan, the contents of which are hereby incorporated by reference.

### BACKGROUND OF THE INVENTION

1. Field of the Invention

The present invention relates to a digital single-reflex camera.

2. Description of the Related Art

Generally, digital cameras have two display modes: the mode that displays the subject through an optical viewfinder (hereinafter called the optical viewfinder mode), and the mode that displays the captured image on a monitor at the rear of the camera (hereinafter called the live view mode). In such digital cameras, one or the other of the display modes can be selected using a selector button.

Usually, the digital camera shoots an image after performing AF (auto focusing) and AE (auto exposure control) in the selected display mode. AF based on phase difference (hereinafter called the phase difference AF) and AF based on contrast detection (hereinafter called the contrast AF or video AF) are known for use in digital cameras.

In prior art digital cameras, when the display mode is switched from one to the other, information obtained before the mode switching has not necessarily been used effectively after the mode switching. Accordingly, the prior art has had the problem of being unable to perform control efficiently.

### SUMMARY OF THE INVENTION

The present invention is directed to an image capturing apparatus.

According to the invention, an image capturing apparatus comprises a viewfinder; an optical system for directing subject light passed through an image taking lens to the viewfinder; an operating member for moving the optical system between a first position and a second position; a first detector operable when the optical system is in the first position, and for detecting an image taking condition; a second detector operable when the optical system is in the second position, and for detecting an image taking condition; a memory for storing the image taking condition detected by the first detector before the optical system is moved; and a controller for controlling a detection area by the second detector by using the image taking condition stored in the memory.

It is therefore an object of the invention is to provide a digital single-reflex camera that can perform control efficiently.

### BRIEF DESCRIPTION OF THE DRAWINGS

In the following description, like parts are designated by like reference numbers throughout the several drawings.

FIG. 1 is a rear view of a digital single-reflex camera according to a first embodiment of the present invention.

FIG. 2 is a cross sectional side view of the digital single-reflex camera.

FIG. 3 is a block diagram showing the detailed configuration of the digital single-reflex camera.

FIG. 4 is a diagram showing AF frames displayed in an optical viewfinder.

FIG. 5 is a rear view of the digital single-reflex camera.

FIG. 6 is a diagram showing focus detection areas displayed on a rear monitor.

FIG. 7 is a diagram showing light metering areas displayed in the optical viewfinder.

FIG. 8 is a diagram showing light metering areas displayed on the rear monitor.

FIG. 9 is a diagram showing the positional relationships among the AF frames, the focus detection areas, and the light metering areas.

FIG. 10 is a diagram showing the AF frames displayed in the optical viewfinder.

FIG. 11 is a diagram showing the focus detection areas displayed on the rear monitor.

FIG. 12 is a diagram showing the light metering areas displayed in the optical viewfinder.

FIG. 13 is a diagram showing the light metering areas displayed on the rear monitor.

FIG. 14 is a flowchart illustrating detailed operation for AF and AE.

FIG. 15 is a flowchart illustrating detailed operation for AF and AE.

FIG. 16 is a diagram showing a table defining correspondences among the positional relationships.

FIG. 17 is a diagram showing the light metering areas displayed in the optical viewfinder.

FIG. 18 is a diagram showing the light metering areas displayed on the rear monitor.

FIG. 19 is a diagram showing the light metering areas displayed in the optical viewfinder.

FIG. 20 is a diagram showing the light metering areas displayed on the rear monitor.

### DETAILED DESCRIPTION OF THE PREFERRED EMBODIMENT

In a digital single-reflex camera according to an embodiment of the present invention, when effecting switching between the optical viewfinder mode and the live view mode, focusing information relating to AF (auto focusing) and exposure control information relating to AE (auto exposure control) obtained before the mode switching are stored for use after the mode switching. The focusing information includes the measured focus detection result (range value) taken before the mode switching and information concerning the subject's two-dimensional position on the display screen at the time of the focus detection. The exposure control information includes the metered light value taken before the mode switching and information concerning the subject's two-dimensional position on the display screen at the time of the light metering.

<Configuration>

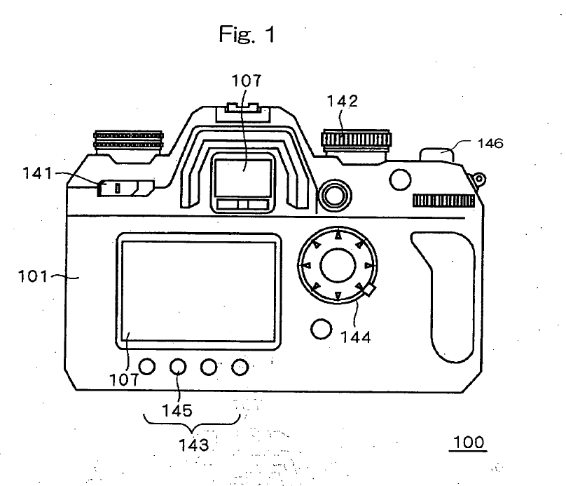

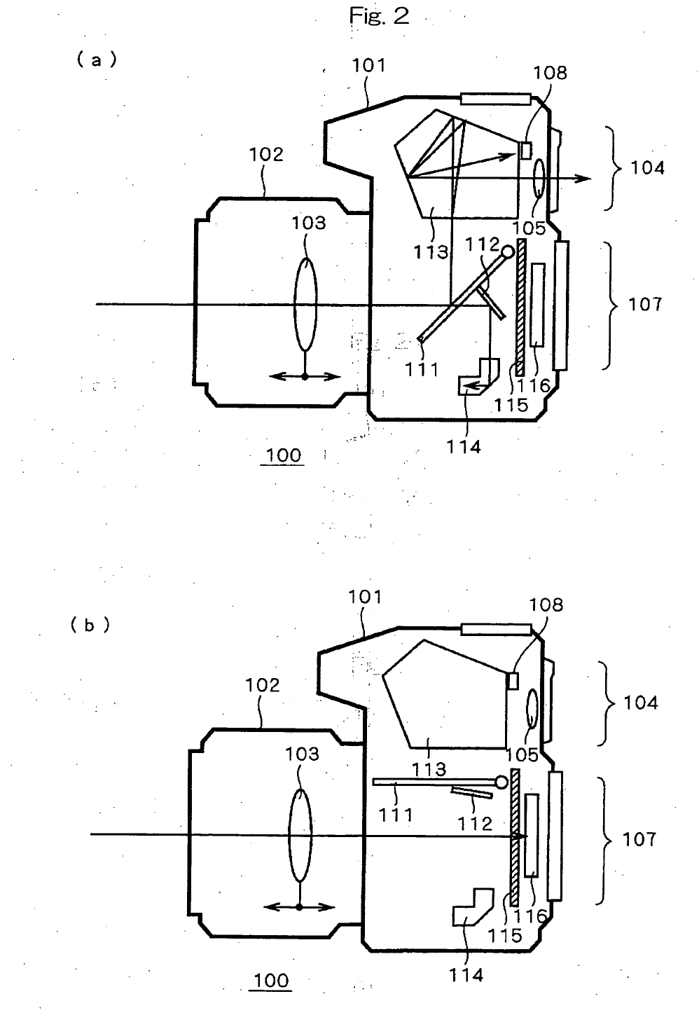

FIG. 1 is a rear view of a digital single-reflex camera 100 according to a first embodiment of the present invention. FIG. 2 is a cross sectional side view of the digital single-reflex camera 100. The function of each part of the digital single-reflex camera 100 will be described below with reference to FIGS. 1 and 2.

An image capturing interchangeable lens unit 102 is attached to a mount of a camera body 101. The interchangeable lens unit 102 contains a plurality of lenses including a focus lens 103. The camera body 101 and the interchangeable lens unit 102 perform data communications with each other via a communication terminal.

A rear monitor 107 is a display device, such as a liquid crystal panel, an organic EL panel, or a plasma display device, which is used to display a live view image being shot or recorded images, etc.

A quick return mirror 111, when in the normal position shown in FIG. 2(a), that is, in the optical path of the interchangeable lens unit 12, reflects the subject light passed through the interchangeable lens unit 12 and thus directs the light upward. The subject light directed upward is passed through a pentaprism 113 and introduced into an optical viewfinder 104 and a light metering sensor 108 mounted near it. The optical viewfinder 104 includes an eyepiece 105, and is constructed so that the subject image focused on a focus plate (not shown) disposed between the quick return mirror 111 and the pentaprism 113 can be viewed through the eyepiece 105. The light metering sensor 108 is a multi-segment light sensor whose light sensing area is divided into a plurality of light metering areas, for example, in a honeycomb pattern so that a metered light value can be obtained for each light metering area.

The center portion of the quick return mirror 111 is formed as a half mirror which allows part of the subject light to pass through it. When the quick return mirror 111 is turned toward the pentaprism 113 and moved to the up position as shown in FIG. 2(b), an optical path to an imaging device 116 is provided. The imaging device 116 can thus capture an image.

A sub mirror 112, which is disposed behind the quick return mirror 111, reflects the subject light passed through the quick return mirror 111 and directs the subject light to a phase difference AF module 114 mounted in the bottom of the camera body 101.

The phase difference AF module 114 first divides the subject light reflected by the sub mirror 112 into two optical path, and then receives the thus divided light by a sensor array to obtain the amount of focus error, i.e., the amount of defocus.

The imaging device 116 is an optical-to-electrical converting device constructed as a two-dimensional sensor such as a CCD or a CMOS, and is immediately preceded by a low pass filter not shown.

A shutter 115 is a focal plane shutter disposed just in front of the imaging device 116.

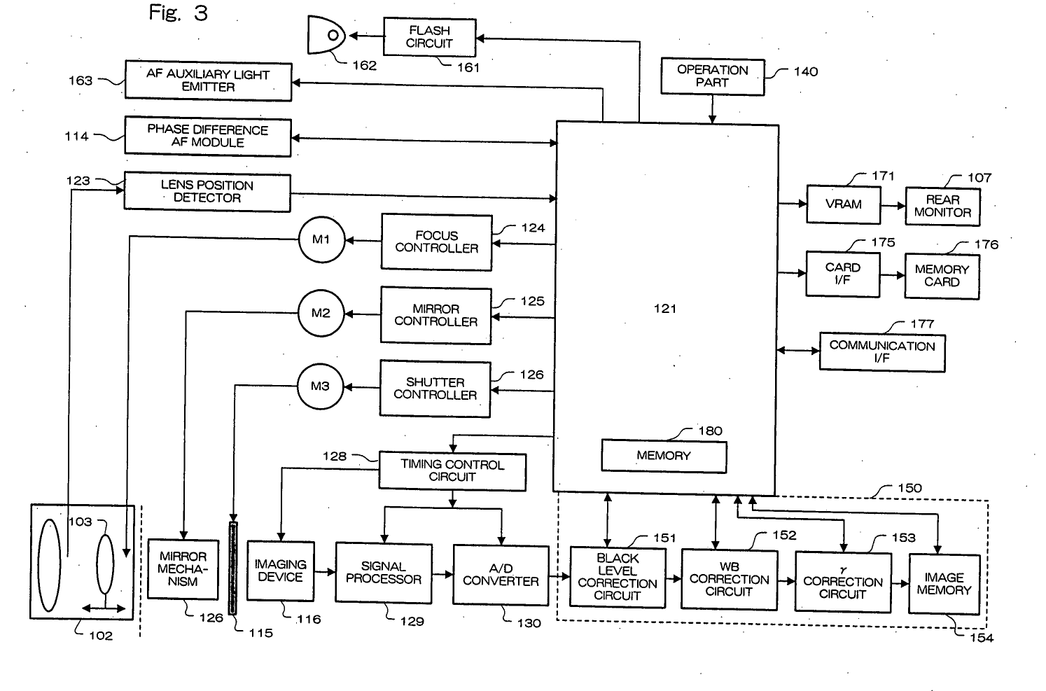

FIG. 3 is a block diagram showing the detailed configuration of the digital single-reflex camera 100.

In FIG. 3, a controller 121 is a main microcomputer which controls the entire operation of the digital single-reflex camera 100 based on a user instruction entered via an operation part 140 or based on the position of the focus lens 103, etc. detected by a lens position detector 123.

A user instruction is entered into the operation part 140 by using a main switch 141, a mode setting dial 142, a setting button array 143, a shutter release button 146, etc. shown in FIG. 1. The shutter release button is a button for directing the initiation of image shooting, and comprises a switch for effecting a two-step operation, i.e., a half-pressed state (S1) for directing the initiation of shooting preparation operations such as light metering and focus detection, and a fully depressed state (S2) for directing the initiation of the image shooting operation (exposure operation).

The controller 121 detects the position of the focus lens 103 within the interchangeable lens unit 102 by using the lens position detector 123. Further, the controller 121 drives the focus lens 103 in the interchangeable lens unit 102 by controlling a motor M1 via a focus controller 124. That is, focusing can be accomplished by moving the focus lens 103 in accordance with the amount of defocus obtained by the phase difference AF module 114. The drive force from the motor M1 is transmitted to the focus lens 103 via a coupler (not shown) incorporated in the mount of the camera body 101. Alternatively, the motor M1 may be incorporated in the interchangeable lens unit 102.

The controller 121 drives the quick return mirror 111 and the sub mirror 112 in the mirror mechanism 126 by controlling a motor M2 via a mirror controller 125.

The controller 121 also drives the shutter 115 by controlling a motor M3 via a shutter controller 127.

Further, the controller 121 controls the CCD imaging device 116, as well as a signal processor 129 and an A/D converter 130, by using a timing control circuit 128.

The image captured by the imaging device 116 is converted by the signal processor 129 and the A/D converter 130 into image data which is supplied to an image processor 150. In the image processor 150, various kinds of correction processing are applied to the image data by a black level correction circuit 151, a WB correction circuit 152, and a γ correction circuit 153, and the processed image data is stored in an image memory 154. The image processor 150 may be accommodated within the same IC as the controller 121, or within a separate IC from the controller 121.

The image data processed by the image processor 150 is displayed on the rear monitor 107 by using a VRAM 171, or recorded on a memory card 176 via a card I/F 175. The image data can also be transmitted to an external device via a communication I/F 177 designed to the USB standard or the like.

The controller 121 activates a flash 162 and, if needed, an AF auxiliary light emitter 163, via a flash circuit 161.

In FIG. 1, the mode setting dial 142 is a dial for setting such modes as shooting mode, playback mode, voice memo mode, communication mode, and setting mode.

The setting button array 143 comprises a plurality of buttons used for such purposes as setting menu screen, image deletion, and FFP (flex focus point) mode setting. The setting button array 143 also includes a selector button 145 for switching between the optical viewfinder mode and the live view mode.

A job dial 144 is a dial that has a plurality of contacts at the top, bottom, left, right, etc., and includes in its center a pushbutton constructed from a separate member. In the shooting mode, a zoom operation is performed by closing either the top or the bottom contact. Further, in the shooting mode, when the pushbutton is pressed, the FFP mode is activated. In the setting mode, a mode or value displayed on the rear monitor 107 is selected by closing one of the top, bottom, left, and right contacts.

<Operation>

First, the using environment of the digital single-reflex camera 100 will be described. It is assumed that the digital single-reflex camera 100 is fixed by the user to a tripod when shooting an image. The image to be shot here may be a still image or a moving image.

The user observes the subject through the optical viewfinder 104 in the optical viewfinder mode. When the shutter release button is pressed halfway, light metering and focus detection are performed. The focus detection is performed by selecting one AF frame from among eleven AF frames. When metering the light, one light metering area in the position corresponding to the AF frame selected for the focus detection is selected from among fourteen light metering areas. Based on the measured light value taken from the selected light measuring area, exposure control values such as shutter speed and aperture setting value are determined. The exposure control values thus determined are displayed within the optical viewfinder 104.

Next, the user moves his eye off the optical viewfinder 104 and, while viewing the rear monitor 107, presses the selector button 145 to switch from the optical viewfinder mode to the live view mode. At this time, the controller 121 causes the quick return mirror 111 to move from the normal position to the up position, and then initiates the image shooting by opening the shutter 115 and thus exposing the imaging device 116. The captured image is displayed as a live view on the rear monitor 107.

Next, the basic operation for the AF performed in each of the optical viewfinder mode and the live view mode will be described with reference to FIGS. 4 to 6.

For the AF in the optical viewfinder mode, phase difference AF is performed using the phase difference AF module 114. On the other hand, for the AF in the live view mode, video AF is performed using the image output from the imaging device 116, because in this mode, the subject light is not input to the phase difference AF module 114 and phase difference AF therefore cannot be performed. Here, the video AF is performed by obtaining the peak of the contrast in the image output from the imaging device 116 while the focus lens 103 is being moved.

FIG. 4 shows a viewfinder display frame 181 which is displayed within the optical viewfinder 104 when performing the phase difference AF in the optical viewfinder mode. Eleven AF frames 182 (AF frames 182a to 182k) indicating the autofocus zones for the phase difference AF are shown within the viewfinder display frame 181. As will be described later, of the AF frames 182, only those which concern the subject are selected and illuminated with LEDs or the like.

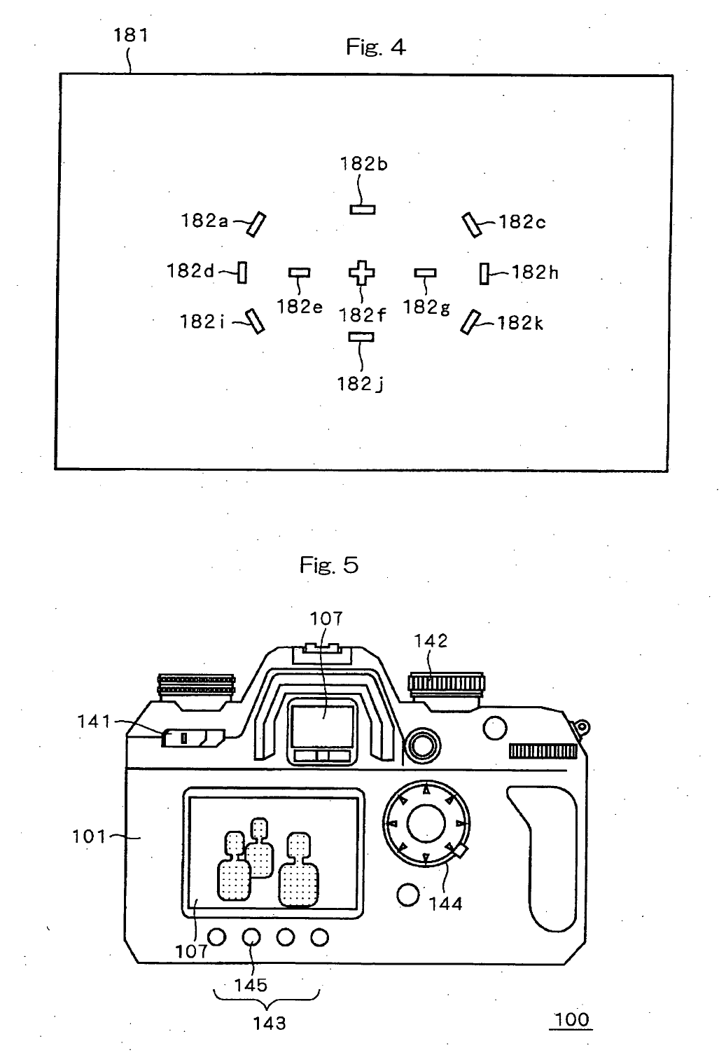

FIG. 5 shows a live view display on the rear monitor 107. When the live view mode is set by the user pressing the selector button 145 included in the setting button array 143, the quick return mirror 111 moves to the up position and the shutter 115 is opened, producing a live view on the rear monitor 107. In the live view, the position where the focus is to be adjusted is indicated by a cursor in an overlaid fashion on the subject image.

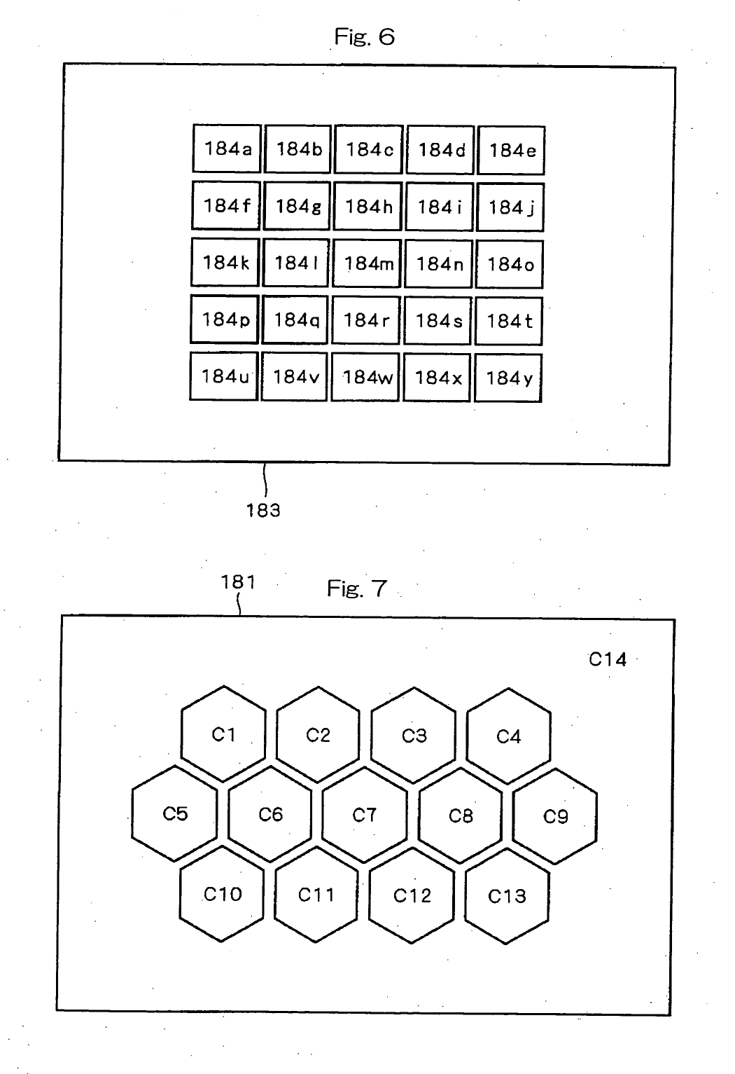

FIG. 6 shows a liquid crystal display frame 183 which is displayed on the rear monitor 107 when performing the video AF using the image contrast in the live view mode. Twenty-five focus detection areas 184 (focus detection areas 184a to 184y) indicating the autofocus zones for the video AF are shown within the liquid crystal display frame 183. In the live view mode, the video AF is performed on the focus detection areas 184. The video AF, which performs focus adjustment by using the image output from the imaging device 116, provides greater freedom in setting the autofocus zones than the phase difference AF does; in principle, focus adjustment can be made in all the areas within the liquid crystal display frame 183. In FIG. 6, the twenty-five focus detection areas 184 are set by dividing the display screen within the liquid crystal display frame 183 into five blocks vertically and five blocks horizontally.

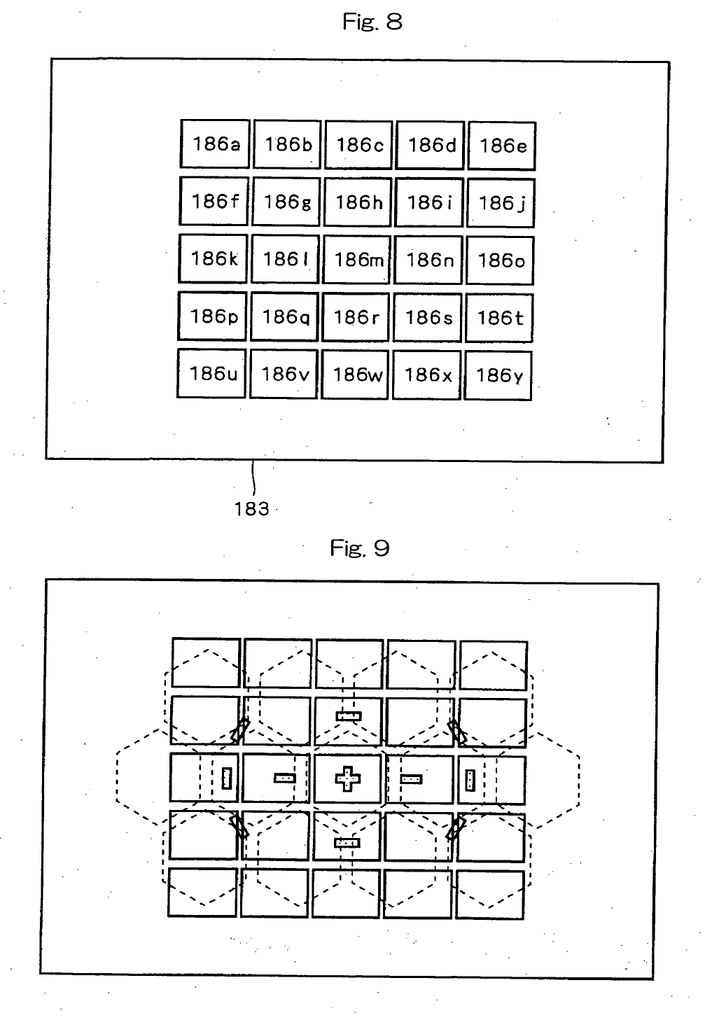

Next, the basic operation for the AE performed in each of the optical viewfinder mode and the live view mode will be described with reference to FIGS. 7 and 8.

For the AE in the optical viewfinder mode, the multi-segment light metering sensor 108 mounted in close proximity to the optical viewfinder 104 is used. On the other hand, for the AE in the live view mode, the image output from the imaging device 116 is used, because in this mode, the subject light is not input to the light metering sensor 108 and the light metering sensor 108 therefore cannot be used.

FIG. 7 shows the viewfinder display frame 181 displayed within the optical viewfinder 104 when performing the AE in the optical viewfinder mode. Thirteen light measuring areas C1 to C13 as cell areas arranged in a honeycomb pattern and one light metering area C14 as a cell area surrounding the honeycomb arrangement are shown within the viewfinder display frame 181.

FIG. 8 shows the liquid crystal display frame 183 displayed on the rear monitor 107 when performing the AE in the live view mode. Similarly to the AF in FIG. 6, twenty-five light metering areas 186 (light metering areas 186a to 186y) for the light metering by the imaging device 116 are shown within the liquid crystal display frame 183. The exposure control using the image output from the imaging device 116 provides greater freedom in setting the light metering areas than the exposure control performed using the light metering sensor 108; in principle, exposure control can be performed in all the areas within the liquid crystal display frame 183. Instead of the twenty-five light metering areas 186, fourteen light metering areas 186 may be arranged in a honeycomb pattern, like those shown in FIG. 7.

Next, the correspondence of the subject's two-dimensional position information in the respective display frames of the optical viewfinder mode and the live view mode will be described with reference to FIGS. 9 to 12.

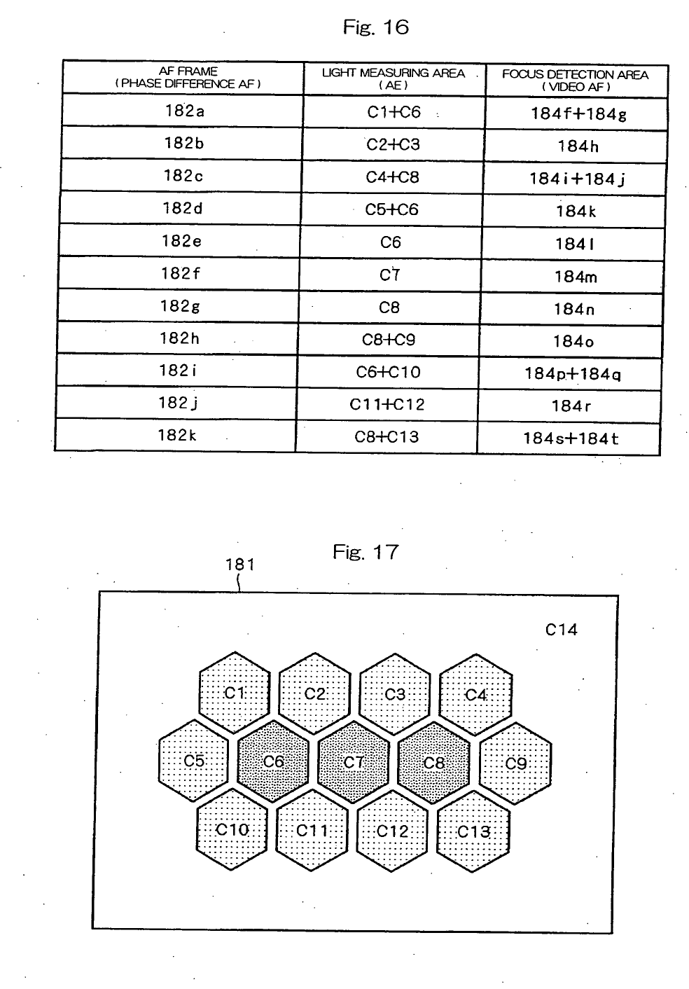

In FIG. 9, the eleven AF frames 182 shown in FIG. 4, the twenty-five focus detection areas 184 shown in FIG. 6, the fourteen light metering areas C1 to C14 shown in FIG. 7, and the twenty-five light metering areas 186 shown in FIG. 8 are shown in overlaid fashion. As will be described later with reference to FIG. 16, by storing these positional relationships in the form of a table or the like, information concerning the subject's two-dimensional position on the display screen can be taken over when switching is made, for example, from the optical viewfinder mode to the live view mode.

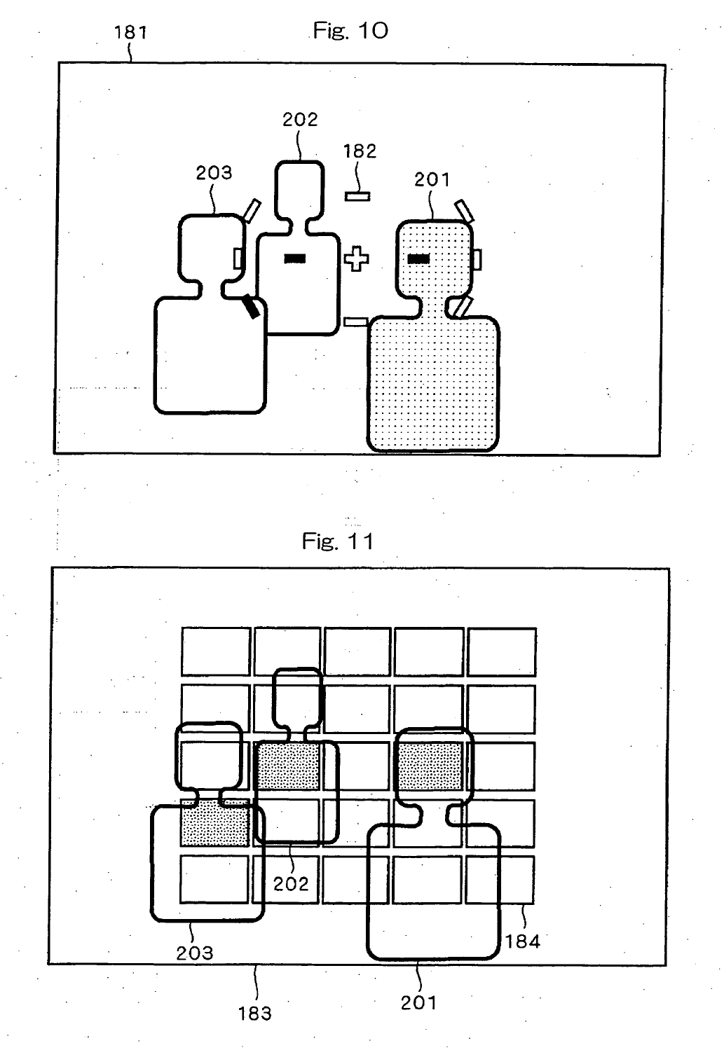

FIG. 10 shows the viewfinder display frame 181 displayed within the optical viewfinder 104 when performing the phase difference AF in the optical viewfinder mode. That is, in FIG. 10, three subjects 201 to 203 are displayed within the display frame shown in FIG. 4. Of the eleven AF frames 182, three AF frames 182 correspond to the respective subjects 201 to 203, and are illuminated with LEDs or the like (in FIG. 10, these three AF frames 182 are shown by solid filled frames). Further, of the three subjects 201 to 203, the subject 201 is selected as the main subject (in FIG. 10, this subject 201 is shown by light hatching). The detection of the main subject can be easily accomplished by using color information concerning the colors (flesh tone colors, etc.) of the respective subjects 201 to 203.

FIG. 11 shows the liquid crystal display frame 183 displayed on the rear monitor 107 when performing the video AF using the image contrast in the live view mode. That is, in FIG. 11, three subjects 201 to 203 are displayed within the display frame shown in FIG. 6. Of the twenty-five focus detection areas 184, three focus detection areas 184 correspond to the respective subjects 201 to 203 (in FIG. 11, these three focus detection areas 184 are shown by heavy hatching). By using the table showing the correspondence of FIG. 9, the positions of the three focus detection areas 184 selected in FIG. 11 can be obtained from the positions of the three AF frames 182 selected in FIG. 10. That is, when switching is made from the optical viewfinder mode to the live view mode, there is no need perform the focus detection in all the focus detection areas 184 shown in FIG. 11, but the focus detection need only be measured in the three focus detection areas 184 corresponding to the respective subjects 201 to 203. This accomplishes effective focus adjustment. Further, by taking over, in addition to the position information, main subject information indicating that the subject 201 is selected as the main subject from among the three subjects 201 to 203, more effective focus adjustment can be accomplished. Here, the positions of the three AF frames 182 selected in FIG. 10 are stored within the controller 121.

FIG. 12 shows the viewfinder display frame 181 displayed within the optical viewfinder 104 when performing the AE using the light metering sensor 108 in the optical viewfinder mode. That is, in FIG. 12, one subject 210 is displayed within the display frame shown in FIG. 7. Of the fourteen light metering areas C1 to C14, three light metering areas C8, C12, and C13 correspond to the subject 210 (in FIG. 12, these three light metering areas C8, C12, and C13 are shown by heavy hatching).

FIG. 13 shows the liquid crystal display frame 183 displayed on the rear monitor 107 when performing the light metering using the image output from the imaging device 116 in the live view mode. That is, in FIG. 13, one subject 210 is displayed within the display frame shown in FIG. 8. Of the twenty-five light metering areas 186, six light metering areas 186 correspond to the subject 210 (in FIG. 13, these six light metering areas 186 are shown by heavy hatching). By using the table showing the correspondence of FIG. 9, the positions of the six light metering areas 186 selected in FIG. 13 can be obtained from the positions of the three light metering areas C8, C12, and C13 selected in FIG. 12. That is, when switching is made from the optical viewfinder mode to the live view mode, there is no need to perform light metering in all the light metering areas 186, but light metering need only be performed in the six light metering areas 186 corresponding to the subject 210. This accomplishes effective exposure control. Further, as in the case of the focus detecting, when there is more than one subject, if provisions are made to take over information indicating which subject is selected as the main subject, more effective exposure control can be accomplished. Here, the positions of the three light metering areas C8, C12, and C13 selected in FIG. 12 are stored within the controller 121.

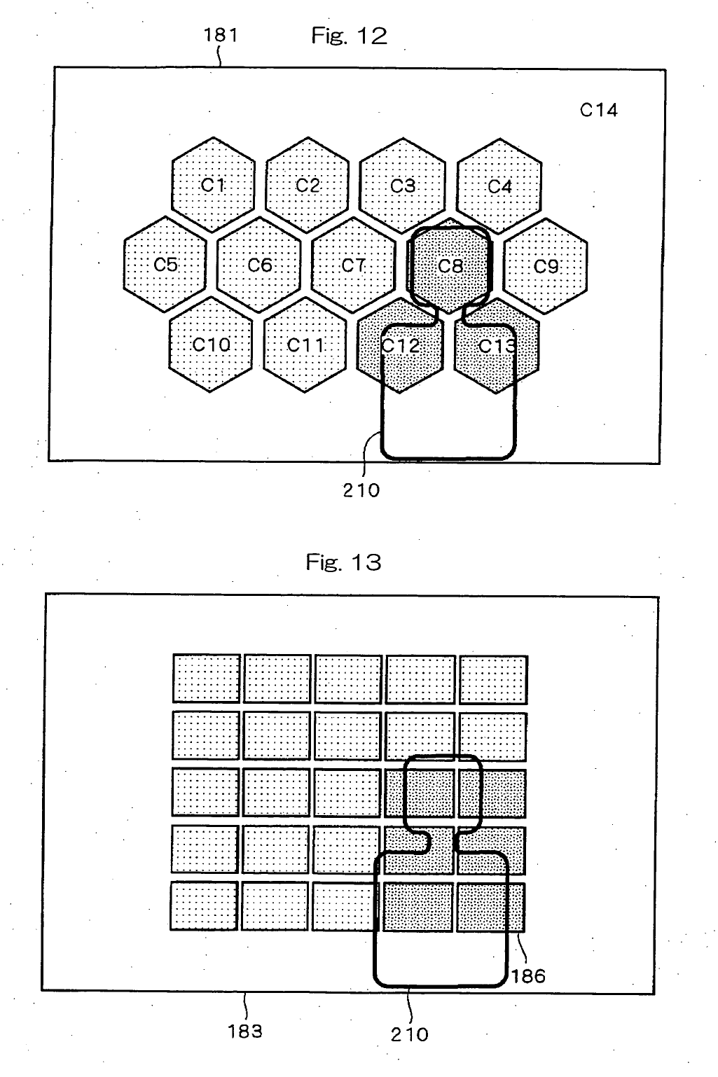

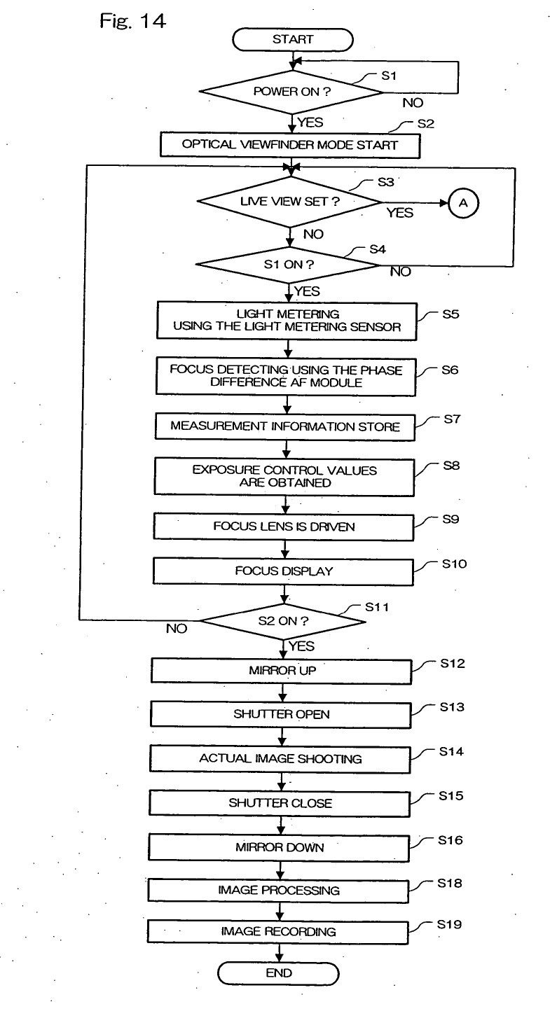

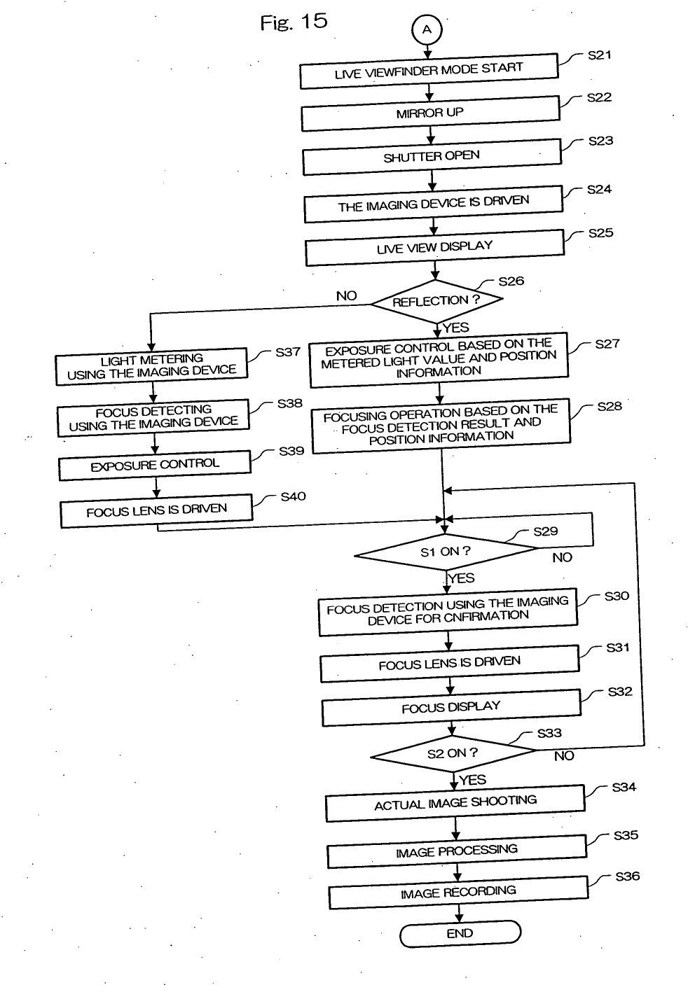

Next, the AF and AE operations in the optical viewfinder mode and the live view mode will be described in detail with reference to the flowcharts of FIGS. 14 and 15.

First, in step S1, it is determined whether the power is turned on by the main switch 141, and the process proceeds to step S2 only when the power is turned on.

In step S2, the display in the optical viewfinder mode is started.

Next, it is determined whether the live view mode is set by the user pressing the selector button 145 (step S3). If the live view mode is set, the process proceeds to step S21 (“A” in FIGS. 14 and 15), but if the live view mode is not set, the process proceeds to step S4.

Next, in step S4, it is determined whether the release button is pressed halfway. If the release button is pressed halfway (S1 ON state), the process proceeds to step S5, but if the release button is not pressed halfway (S1 OFF state), the process proceeds to step S3.

In step S5, multi-segment light metering is performed using the light metering sensor 108, and in step S6, focus detecting (range measurement) is performed using the phase difference AF module 114.

Next, the process proceeds to step S7 where the metered light value obtained in step S5 and the measured focus detection result (range value) obtained in step S6 are stored as measurement information in a memory 180 provided within the controller 121. At this time, information concerning the position of the subject detected in the light metering step S5 and the focus detecting step S6 is also stored as measurement information in the memory 180. The position information is, for example, the information indicating the positions of the three light metering areas C8, C12, and C13 corresponding to the subject 210 in FIG. 12 in the case of the light metering step S5, and the information indicating the positions of the three AF frames 182 corresponding to the subjects 201 to 203 in FIG. 10 in the case of the focus detecting step S6.

Then, the process proceeds to step S8 where exposure control values are obtained based on the metered light value obtained in step S5, while in step S9, the amount of defocus is obtained based on the measured focus detection result obtained in step S6, and the focus lens 103 is driven accordingly. The focusing operation is thus accomplished. Then, in step S10, a focus display is produced within the optical viewfinder 104.

Next, the process proceeds to step S11 to determine whether the release button is fully depressed or not. If the release button is fully depressed (S2 ON state), the process proceeds to step S12, but if the release button is not fully depressed (S2 OFF state), the process proceeds to step S3.

Next, the quick return mirror 111 is moved to the up position (step S12), and the shutter 115 is opened (step S13).

Next, the process proceeds to step S14 where the actual image shooting for recording (exposure operation) is performed using the imaging device 116, and the shutter 115 is closed (step S15). After the shutter is closed, the quick return mirror 111 is moved down to its normal position (step S16).

Next, the process proceeds to step S17 where the image shot in step S14 is processed by the image processor 150, and in step S18, the image processed in step S17 is recorded on the memory card 176, etc. With the operations in the above steps S1 to S18, the image shooting and recording in the optical viewfinder mode is accomplished.

On the other hand, if the live view mode is set in step S3, the process proceeds to step S21 in FIG. 15 to start the display in the live view mode.

First, in step S22, the quick return mirror 111 is moved to the up position, and the shutter 115 is opened (step S23).

Next, in step S24, the driving of the imaging device 116 is started, and the image obtained by the imaging device 116 is displayed on the rear monitor 107 in Step S25 (live view display).

Next, the process proceeds to step S26 to determine whether any setting is made so that the metered light value, focus detection result, and position information stored in step S7 of the optical viewfinder mode are reflected in the live view mode. If the setting is made so as to reflect the metered light value, focus detection result, and position information thus stored, the process proceeds to step S27, but if no setting is made to reflect them, the process proceeds to step S37. Here, when the mode is switched to the live view mode before obtaining the metered light value and the focus detection result in the optical viewfinder mode (that is, when the selector button 145 is pressed before the release button is half-pressed in the optical viewfinder mode), the process also proceeds to step S37 because there is no metered light value or focus detection result to reflect.

In step S27, exposure control is performed by computing exposure control values based on the metered light value and position information stored in step S7. That is, by using the stored positions of the three light metering areas C8, C12, and C13 (see FIG. 12), the positions of the six light metering areas 186 corresponding to the subject 210 in FIG. 13 can be quickly obtained. Further, by using the metered light value stored in the optical viewfinder mode, exposure control values including the shutter speed, aperture setting value, and image output gain (amplification factor) in the live view mode can be properly determined. In the live view mode, the shutter speed corresponds to the exposure time of the imaging device 116 (that is, integration time on the CCD).

If the metered light value in each of the light metering areas C8, C12, and C13 stored in the optical viewfinder mode is within a predetermined range, the gain corresponding to ISO sensitivity is set to a standard value (for example, ISO 100). If, for example, the metered light value is lower than the lower limit of the predetermined range, the sensitivity is raised by setting the gain higher than the standard value (for example, to ISO 200 or ISO 400). In step S7, the metered light values in all the light metering areas C1 to C14 may be stored, or the metered light values only in the light metering areas C8, C12, and C13 may be stored.

In the live view mode, images are captured in rapid succession by the imaging device 116 and sequentially displayed for live view on the rear monitor 107. The live view display presents the captured images at a rate of 30 frames per second. As a result, in the live view display, the integration time on the imaging device 116 is limited compared with that for the actual image shooting, and therefore, the value is different from that for the actual image shooting. Accordingly, the aperture setting value, gain, etc. are also different from those for the actual image shooting. In the present embodiment, the values such as the integration time on the imaging device 116, the aperture value, the gain, etc. suitable for the live view display are determined by using the metered light values in the light metering areas C8, C12, and C13.

Next, the process proceeds to step S28 where the amount of defocus is determined based on the focus detection result and position information stored in step S7, and the focusing operation is performed by driving the focus lens 103. That is, by using the stored positions of the three AF frames 182 (see FIG. 10), the positions of the three focus detection areas 184 corresponding to the subjects 201 to 203 in FIG. 11 can be quickly obtained. Further, since the focus detection result stored in the optical viewfinder mode is used, the focus adjustment in the live view mode can be performed smoothly. That is, in the present embodiment, since the focusing operation is performed in step S9 of the optical viewfinder mode, if the focus position does not change before and after the switching from the optical viewfinder mode to the live view mode, for example, the position of the focus lens 103 remains unchanged in step S28.

Next, the process proceeds to step S29 to determine whether the release button is pressed halfway; if the release button is pressed halfway (S1 ON state), the process proceeds to step S30.

When the release button is pressed halfway, the focus detection using the imaging device 116 is performed in step S30 for confirmation.

Then, the process proceeds to step S31 where the focus lens 103 is driven based on the focus detection result obtained in step S30. The focusing operation for confirmation is thus accomplished.

Next, in step S32, a focus display is produced on the rear monitor 107, and in step S33, it is determined whether the release button is fully depressed or not. If the release button is fully depressed (S2 ON state), the process proceeds to step S34, but if the release button is not fully depressed (S2 OFF state), the process proceeds to step S29.

After the actual image shooting for recording (exposure operation) is performed in step S34 using the imaging device 116, the image shot for recording is processed by the image processor 150 (step S35), and the image is then recorded on the memory card 176, etc. (step S36).

On the other hand, if it is determined in step S26 that the metered light value, focus detection result, and position information stored in step S7 of the optical viewfinder mode are not set so as to be reflected in the live view mode, the process proceeds to step S37.

First, in step S37, light metering is performed using the imaging device 116, and then in step S38, focus detecting is performed using the imaging device 116.

In step S39, exposure control is performed by obtaining exposure control values based on the metered light value obtained in step S37.

Next, the process proceeds to step S40 where the focusing operation is performed by driving the focus lens based on the focus detection result obtained in step S38, and then the process proceeds to step S29. With the operations in the above steps S21 to S40, the image shooting and recording in the live view mode is accomplished.

FIG. 16 is a table defining the positional relationships shown in FIG. 9. That is, since the AF frames 182, the focus detection areas 184, the light metering areas C1 to C14, and the light metering areas 186 are independent of one another, their positional relationships must be stored in the form of a table or the like in the digital single-reflex camera 100. As shown in FIG. 16, the AF frames 182, the light metering areas C1 to C14, and the focus detection areas 184 do not always correspond one for one since they differ in number. Accordingly, as shown in FIG. 10, the position information is reflected over two light metering areas or two focus detection areas, depending on the position of the selected AF frame. In this case, the two light metering areas or the two focus detection areas may be selected by assigning equal weights to them, or by assigning a heavier weight to the one located nearer to the selected AF frame and a lighter weight to the other one which is farther from the selected AF frame. Alternatively, of the two light metering areas or the two focus detection areas, only the one located nearer to the selected AF frame may be selected.

For example, the subject 201 as the main subject shown in FIG. 10 corresponds to the AF frame 182g. In the table shown in FIG. 16, the AF frame 182g corresponds to the focus detection area 184n. Therefore, when switching is made to the live view mode, the video AF is performed in the focus detection area 184n.

When the switching to the live view mode is performed before the focusing operation by the phase difference AF is completed, the digital single-reflex camera 100 causes the quick return mirror 111 to move up and opens the shutter 115. Then, after moving the focus lens 103 to or near the focus position based on the information (focus detection result) obtained by the phase difference AF, the digital single-reflex camera 100 initiates the video AF in the focus detection area 184n.

In this way, according to the digital single-reflex camera 100 of the present embodiment, when switching is made between the optical viewfinder mode and the live view mode, the information obtained before the mode switching is reflected in the control performed after the mode switching. Accordingly, the control can be performed efficiently. As a result, needless movement of the focus lens 103, etc. is reduced, and smooth switching can be accomplished.

While the above description has dealt with the case where the switching is made from the optical viewfinder mode to the live view mode, the invention is not limited to this particular case but is also applicable to the case where the switching is made from the live view mode to the optical viewfinder mode.

Further, in the digital single-reflex camera 100, the image is observed through the optical viewfinder 104 in the still image shooting mode, while the image is presented for viewing on the rear monitor 107 in the moving image shooting mode. Accordingly, when switching between the still image shooting mode and the moving image shooting mode, if the information obtained before the mode switching is reflected in like manner in the control performed after the mode switching, the control can be performed efficiently. The mode switching here is performed using the shutter release button.

The above description has also dealt with the case where the live view mode is started after moving the focus lens 103 for focusing based on the measured focus detection result in the optical viewfinder mode. However, in the optical viewfinder mode, only the focus detection may be performed, and after the live view mode is started, the focus lens 103 may be moved for focusing based on the measured focus detection result.

Further, in the digital single-reflex camera 100, a spot AF mode, which performs focusing only on a specific area, and a wide AF mode, which performs focusing on an area wider than the specific area, are available for selection depending on the position of the subject. In this case, if information indicating which AF mode, the spot AF mode or the wide AF mode, is selected is stored before effecting switching between the optical viewfinder mode and the live view mode, with provisions made to use the stored information after effecting the switching between the optical viewfinder mode and the live view mode, then it becomes possible to perform the control more efficiently.

A motion predictive AF mode which predicts the direction of motion of the subject is also available for selection in the digital single-reflex camera 100. In this case, if information concerning the predicted direction of motion of the subject is stored before effecting switching between the optical viewfinder mode and the live view mode, with provisions made to use the stored information after effecting the switching between the optical viewfinder mode and the live view mode, then it becomes possible to perform the control more efficiently.

Further, an AF lock or AE lock which can lock the focus detection result (range value) or metered light value by half-pressing the release button can also be employed in the focus detection or light metering operation. In this case, if the measured focus detection result or metered light value thus locked is stored before effecting switching between the optical viewfinder mode and the live view mode, with provisions made to use the stored focus detection result or metered light value after effecting the switching between the optical viewfinder mode and the live view mode, then it becomes possible to perform the control more efficiently.

Further, the above description has been given with reference to FIGS. 12 and 13 for the case where the multi-segment light metering is performed, but the invention is not limited to the multi-segment light metering; instead, center-weighted averaging light metering or spot light metering may be performed.

FIG. 17 shows the viewfinder display frame 181 displayed within the optical viewfinder 104 in the optical viewfinder mode when performing the center-weighted averaging light metering. As shown in FIG. 17, in the center-weighted averaging light metering, a total of three light metering areas consisting of the center light metering area C7 and the light metering areas C6 and C8 adjacent to the left and right thereof are more heavily weighted than the eleven light metering areas C1 to C5 and C9 to C14 surrounding them. FIG. 18 shows a live view display on the rear monitor 107 in corresponding relationship to FIG. 17. In FIG. 18, a total of three light metering areas consisting of the center light metering area 186m and the light metering areas 186l and 186n adjacent to the left and right thereof are more heavily weighted than the twenty-two light metering areas 186 surrounding them.

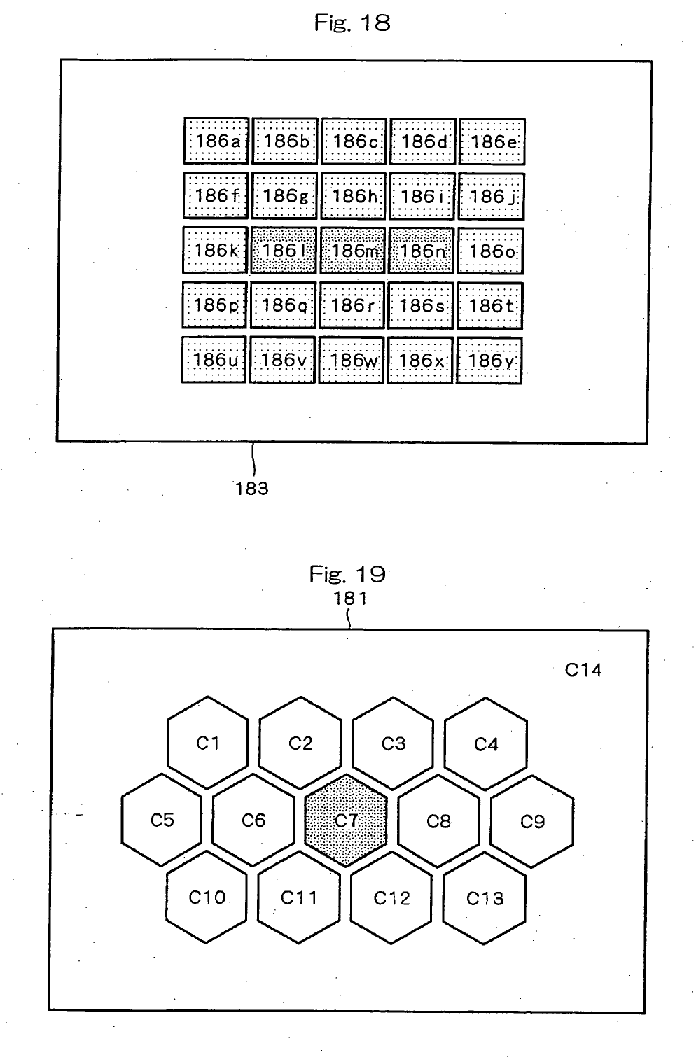

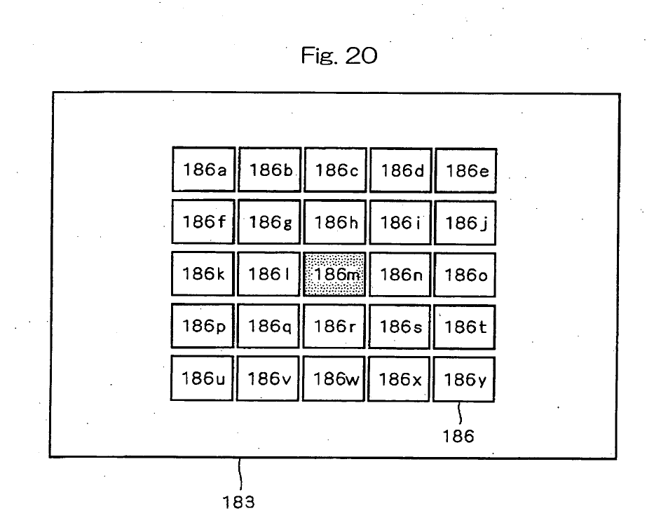

FIG. 19 shows the viewfinder display frame 181 displayed within the optical viewfinder 104 in the optical viewfinder mode when performing the spot light metering. As shown in FIG. 19, in the spot light metering, light is metered only in the center light metering area C7. FIG. 20 shows a live view display on the rear monitor 107 in corresponding relationship to FIG. 19. In FIG. 20, light is metered only in one light metering area 186m located in the center.

Here, if the metered light value obtained by the center-weighted averaging light metering or by the spot light metering before effecting switching between the optical viewfinder mode and the live view mode is reflected as control information after effecting the switching between the optical viewfinder mode and the live view mode, it becomes possible to perform the control efficiently, as in the case of the multi-segment light metering.

Although the present invention has been fully described by way of examples with reference to the accompanying drawings, it is to be noted that various change and modifications will be apparent to those skilled in the art. Therefore, unless otherwise such changes and modifications depart from the scope of the present invention, they should be construed as being including therein.

What is claimed is:

1. An image capturing apparatus comprising:
a viewfinder;
an optical system for directing subject light passed through an image taking lens to the viewfinder;
an operating member for moving the optical system between a first position and a second position;
a first detector operable when the optical system is in the first position, and for detecting an image taking condition;
a second detector operable when the optical system is in the second position, and for detecting an image taking condition;
a memory for storing the image taking condition detected by the first detector before the optical system is moved; and
a controller for controlling a detection area by the second detector by using the image taking condition stored in the memory.

2. The image capturing apparatus according to claim 1, wherein the viewfinder is an optical viewfinder and wherein the optical system is a mirror.

3. The image capturing apparatus according to claim 2, wherein the first position is a position that allows the subject light to be directed to the optical viewfinder, and wherein the second position is a position in which the mirror is held when the mirror is moved up.

4. The image capturing apparatus according to claim 1, wherein the operating member is a member for starting the shooting an image.

5. The image capturing apparatus according to claim 1, wherein the operating member is a switch for switching between a mode for electrically displaying an image and a mode for optically displaying an image.

6. An image capturing apparatus comprising:
a viewfinder;
an optical system for directing subject light passed through an image taking lens to the viewfinder;
an operating member for moving the optical system between a first position and a second position;
a first focus detector operable when the optical system is in the first position, and for detecting a focus condition of the taking lens;
a second focus detector operable when the optical system is in the second position, and for detecting a focus condition of the taking lens;
a memory for storing the focus condition detected by the first focus detector before the optical system is moved; and
a controller for controlling the second focus detector by using the focus condition stored in the memory.

7. The image capturing apparatus according to claim 6, wherein the first focus detector detects the focus condition of the image taking lens based on a phase difference method, and wherein the second focus detector detects the focus condition of the image taking lens based on image data output from an image sensor.

8. The image capturing apparatus according to claim 6, wherein the focus condition includes information concerning at least a focus detection area in the subject.

9. The image capturing apparatus according to claim 8, wherein the controller controls the focus detection area by the second focus detector based on the information.

10. The image capturing apparatus according to claim 9, wherein the controller selects the focus detection area by the second focus detector based on a main subject position detected by the first focus detector.

11. The image capturing apparatus according to claim 6, wherein the focus condition includes information concerning at least a focus detection result.

12. An image capturing apparatus comprising:
a viewfinder;
an optical system for directing subject light passed through an image taking lens to the viewfinder;
an operating member for moving the optical system between a first position and a second position;
a first light metering sensor operable when the optical system is in the first position, and for detecting a lighting condition of the subject;
a second light metering sensor operable when the optical system is in the second position, and for detecting a lighting condition of the subject;
a memory for storing the lighting condition detected by the first light metering sensor before the optical system is moved; and
a controller for controlling the second light metering sensor by using the lighting condition stored in the memory.

13. The image capturing apparatus according to claim 12, wherein the light metering sensor is mounted near the viewfinder, and wherein the second light metering sensor is an image sensor.

14. The image capturing apparatus according to claim 13, wherein the controller controls an exposure of the image sensor.

15. The image capturing apparatus according to claim 12, wherein the lighting condition includes information concerning to a light metering area.

16. The image capturing apparatus according to claim 15, wherein the controller controls the light metering area by the second light metering sensor based on the information.

17. The image capturing apparatus according to claim 16, wherein the controller selects the light metering area by the second light metering sensor based on a main subject position detected by the first light metering sensor.

18. The image capturing apparatus according to claim 12, wherein the lighting condition includes information concerning to a light metering result.

19. An image capturing method of an image capturing apparatus having a viewfinder and an optical system for directing subject light passed through an image taking lens to the viewfinder, comprising the step of:
detecting an image taking condition by a first detector when the optical system is in a first position;
storing the detected image taking condition in a memory;
moving the optical system from the first position to a second position;
determining a detection area by a second detector for detecting an image taking condition by using the image taking condition stored in the memory when the optical system is in a second position; and
controlling the second detector.
